(19) United States
(12) Patent Application Publication
(10) Pub. No.: US 2020/0133979 A1
(43) Pub. Date: Apr. 30, 2020

(54) COMPUTER-IMPLEMENTED METHOD FOR QUANTIFYING CHEMICAL HAZARD ASSESSMENT

(71) Applicant: Scivera LLC, Charlottesville, VA (US)

(72) Inventors: Joseph Rinkevich, Charlottesville, VA (US); Bradley Groff, Charlottesville, VA (US); Patricia Beattie, University Park, FL (US); Colleen McLoughlin, Schuyler, VA (US); James Orchard-Hays, Charlottesville, VA (US); Elizabeth Murray, Chestnut Hill, MA (US)

(73) Assignee: Scivera LLC, Charlottesville, VA (US)

(21) Appl. No.: 16/663,288

(22) Filed: Oct. 24, 2019

Related U.S. Application Data
(60) Provisional application No. 62/750,188, filed on Oct. 24, 2018.

(51) Int. Cl. G06F 16/9035; G06F 16/9038

(52) U.S. Cl. CPC G06F 16/9035; G06F 16/9038

(57) ABSTRACT

A computer-implemented quantitative hazard scoring method is described. The method allows a large population of chemicals to be scored for their relative hazard potential and compared with one another. The method allows a user to provide one or more chemical identifiers and receive a quantitative hazard score based on the one or more chemical identifiers according to an algorithm.

### CROSS-REFERENCE TO RELATED APPLICATIONS

The present application relies on the disclosures of and claims priority to and the benefit of the filing date of U.S. Provisional Application No. 62/750,188, filed Oct. 24, 2018. The disclosures of that application are hereby incorporated by reference herein in their entireties.

### BACKGROUND OF THE INVENTION

### Field of the Invention

The present invention is in the field of toxicology. More particularly, embodiments of the invention provide methods, algorithms, computer program products, and systems for quantitative assessment of chemical hazards.

### Description of Related Art

There currently exist a minimum number of approaches to rating chemicals for safety, most of which are only qualitative in nature. Regulatory requirements across most global markets and jurisdictions require industrial chemicals to include a safety rating and accompanying labeling. Conventional regulatory requirements for chemical safety ratings increasingly follow the United Nations Globally Harmonized System (“GHS”) for Classification and Labeling of Chemicals. (See http://www.unece.org/index.php?id=46260). Other current approaches for evaluating chemical human and environmental health hazards include the United States Environmental Protection Agency's Safer Choice® Program Alternatives Assessment Criteria as well as the GreenScreen® for Safer Chemicals Chemical Hazard Assessment Framework. (See https://www.epa.gov/saferchoice/alternatives-assessment-criteria-hazard-evaluation; https://www.greenscreenchemicals.org/learn/full-greenscreen-method). Qualitative hazard assessment frameworks, like Scivera's GHS+ Hazard Category Score (e.g., red, yellow, green, gray), U.S. Environmental Protection Agency's Safer Choice® (pass/fail), and the GreenScreen® for Safer Chemicals (e.g., Benchmark 1,2,3,4, and U), among others, are somewhat useful for organizing chemicals by key characteristics (e.g., Carcinogenicity, Mutagenicity, Reproductive Toxicity, Developmental Toxicity/Persistence, Bioaccumulation/Aquatic Toxicity “CMRD/PBT”), but this approach results in large numbers of chemicals in each category, especially the middle, conditional, category.

The complexity and dynamic nature of successive and recurring calculations and recalculations of endpoint, raw, and index scores quickly becomes impractical, if not impossible, for manual processing without computational processing capabilities. Thus, there is a need in the art for a computer-implemented and improved toxicological scoring system that overcomes current limitations.

### SUMMARY OF THE INVENTION

Embodiments of the present invention improve on these established approaches by offering an additional level of evaluating a chemical for human and environmental health by moving from the qualitative results of the prior approaches to a quantitative score. Conditional chemicals scored via a qualitative method can benefit significantly from a quantitative score to quickly rank various alternatives for their subtle attribute differences.

Embodiments of the present invention provide methods, computer program products, and systems for calculating a numeric score to represent the overall human and environmental health hazard assessment of industrial chemicals. In a computer program product embodiment, a service platform preliminarily called SciveraLENS® may be used by global consumer products brands as well as their extensive and diverse chemical and material supplier network participants to calculate the numerical score. Embodiments of the methods, computer program products, and systems aggregate and automate complex toxicological assessment results across a large number (for example, 23 in a preferred embodiment) of categories (i.e., toxicological hazard assessment endpoints) of human and environmental health and render an objective numeric score to enable efficient and objective comparison of chemicals, formulations, and complex articles for a variety of tasks. According to embodiments, the methods, computer program products, and systems enable large numbers of individual chemicals, as well as large datasets of formulations or complex articles to be evaluated quickly, consistently, and cost-effectively by experts and non-experts for more informed decision-making for achievement against product compliance, product quality, product stewardship, and Environment Sustainability Governance (“ESG”) goals, which requires computer intervention and cannot be performed by human calculations alone.

According to one embodiment, the invention provides a method of quantitative assessment of one or more chemical hazards. The method includes the steps of providing one or more chemical identifiers, querying a database of information on a plurality of toxicity endpoints based on the one or more chemical identifiers, assigning a numeric hazard score to each endpoint of the plurality of endpoints based on the information in the database, summing the numeric hazard scores for the plurality of endpoints to obtain a raw score, and dividing the raw score by a total possible score to obtain a quantitative index adjusted score. The querying, assigning, summing, and dividing steps are performed by one or more processors and could not be performed by a human based, in part, on the large datasets, the necessity of the Internet and other computer processes to perform the invention, and the breadth of information and speed necessary to make the invention perform as intended.

According to another embodiment, a numeric score, i.e., the Quantitative Chemical Hazard Assessment Endpoint Score, is assigned to each of 23 toxicological endpoints based on the hazard condition assessed for that endpoint.

According to another embodiment, a score factor is applied to Core Endpoints to establish greater weight as compared to Supplemental Endpoints.

According to another embodiment, a resulting Quantitative Chemical Hazard Assessment Raw Score from 0-297, from 0-300, from 0-500, from 0-1000, and so on (or any other numbering or other system for quantifying a score/value/analysis/weight, for example) is calculated for each chemical.

According to another embodiment, a Quantitative Chemical Hazard Assessment Index Score from 0-100 is calculated for each chemical.

According to another embodiment, a large dataset of chemicals and their respective human and environmental health attributes can be processed and evaluated for consistencies and differences in safety.

According to another embodiment, chemicals can be categorized by functional use for rapid and objective comparison as potential alternatives to a chemical restricted by regulations.

According to another embodiment, large populations of currently unregulated chemicals can be scored and compared to chemicals currently under regulation or restriction to predict their likelihood of restriction or regulation based on underlying human and environmental health characteristics.

### BRIEF DESCRIPTION OF THE DRAWINGS

The accompanying drawings illustrate certain aspects of embodiments of the present invention, and should not be used to limit the invention. Together with the written description the drawings serve to explain certain principles of the invention.

FIG. 1 is a table showing the possible Quantitative Chemical Hazard Assessment Endpoint Scores based on toxicological hazard assessment condition according to an embodiment.

FIG. 2 is a table showing the GHS+ Toxicological Hazard Assessment Endpoints including Core designations according to an embodiment.

FIG. 3 is a table showing the GHS+ Toxicological Hazard Assessment Endpoints including Supplemental designations according to an embodiment.

FIG. 4 is a table that shows one possible embodiment of output of Quantitative Chemical Hazard Assessment Scores for endpoints, as well as raw and adjusted, for a sample set of chemicals based on toxicological hazard assessment conditions across 23 toxicological endpoints according to an embodiment.

FIG. 5 is a diagram of one possible algorithm according to the current invention for calculating, monitoring, and notifying of changes to the Quantitative Chemical Hazard Assessment Endpoint Scores for a chemical based on toxicological hazard assessment conditions across 23 endpoints according to an embodiment.

FIG. 6 is a diagram of one possible algorithm according to the current invention for calculating, monitoring, and notifying of changes to the Raw and Adjusted Quantitative Chemical Hazard Assessment Scores.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

Embodiments of the present invention include a method or algorithm for providing a quantitative toxicological score for assessing the hazard of one or more chemicals. Any algorithm described herein can be embodied in software or set of computer-executable instructions capable of being run on a computing device or devices. The computing device or devices can include one or more processor (CPU) and a computer memory. The computer memory can be or include a non-transitory computer storage media such as RAM which stores the set of computer-executable (also known herein as computer readable) instructions (software) for instructing the processor(s) to carry out any of the algorithms, methods, or routines described in this disclosure. As used in the context of this disclosure, a non-transitory computer-readable medium (or media) can include any kind of computer memory, including magnetic storage media, optical storage media, nonvolatile memory storage media, and volatile memory. Non-limiting examples of non-transitory computer-readable storage media include floppy disks, magnetic tape, conventional hard disks, CD-ROM, DVD-ROM, BLU-RAY, Flash ROM, memory cards, optical drives, solid state drives, flash drives, erasable programmable read only memory (EPROM), electrically erasable programmable read-only memory (EEPROM), non-volatile ROM, and RAM. The computer-readable instructions can be programmed in any suitable programming language, including JavaScript, C, C #, C++, Java, Python, Perl, Ruby, Swift, Visual Basic, and Objective C. Embodiments of the invention also include a non-transitory computer readable storage medium having any of the computer-executable instructions described herein.

A skilled artisan will further appreciate, in light of this disclosure, how the invention can be implemented, in addition to software and hardware, using one or more firmware. As such, embodiments of the invention can be implemented in a system which includes any combination of software, hardware, or firmware. In the context of this specification, the term “firmware” can include any software programmed onto the computing device, such as a device's nonvolatile memory. Thus, systems of the invention can also include, alternatively or in addition to the computer-executable instructions, various firmware modules configured to perform the algorithms of the invention.

According to embodiments, the computing device or devices can include a mainframe computer, web server, database server, desktop computer, laptop, tablet, netbook, notebook, personal digital assistant (PDA), gaming console, e-reader, smartphone, or smartwatch, which may include features such as a processor, memory, hard drive, graphics processing unit (GPU), and input/output devices such as display, keyboard, and mouse or trackpad (depending on the device).

Additional embodiments of the invention include a networked computer system for carrying out the method of the invention. The computer system can include one or more computing devices which can include a processor for executing the computer-executable instructions, one or more databases, a user interface, and a set of instructions (e.g., software) for carrying out the method. According to other embodiments, the computing device or devices are connected to a network through any suitable network protocol such as IP, TCP/IP, UDP, or ICMP, such as in a client-server configuration and one or more database servers. The network can use any suitable network protocol and can be any suitable wired or wireless network including any local area network, wide area network, Internet network, telecommunications network, Wi-Fi enabled network, or Bluetooth enabled network.

The information in the database(s) can include information on toxicology testing of various compounds, including one or more of the 23 endpoints described herein, although the invention contemplates more or less endpoints than the preferred 23. Further, the information in the database(s) can be curated from the toxicology literature and/or populated from external databases which include various toxicology data and information. Publically available external toxicology databases include the databases on TOXNET (U.S. National Library of Medicine, Bethesda, Md.), which include the Hazardous Substances Data Bank (HSDB), TOXLINE, ChemIDplus, Developmental and Reproductive Toxicology Database (DART), Comparative Toxicogenomics Database (CTD), Integrated Risk Information System (IRIS), International Toxicity Estimates for Risk (ITER), Chemical Carcinogenesis Research Information System (CCRIS), Carcinogenic Potency Database (CPD), and the Genetic Toxicology Data Bank (GENE-TOX), among others. Publically available external toxicology databases also include those sponsored by the United States Environmental Protection Agency (EPA), which include the Aggregated Computational Toxicology Resource (ACToR), DSS Tox, ToxCast, the Toxicity Reference Database (ToxRefDB), and ECOTOX Databases, among others. The information in the database(s) can be populated from any publicly available source known at the time of this disclosure or which becomes known afterward.

The computer-executable instructions can include those which provide a graphical user interface made available on one or more client computers. The graphical user interface can allow a user on a client computer remote access to the method or algorithm for providing a quantitative toxicological score hosted on one or more servers. For example, the graphical user interface on the client computer can allow input of one or more chemicals (e.g., by chemical name, CAS Registry Number®, or other identifier) by way of a prompt, search box, pull-down menu, and the like. The input can then be communicated by way of any suitable network protocol to the server. In response to the input, the algorithm embodied in software hosted on the server can calculate a Quantitative Chemical Hazard Assessment Index Score based on information available in the one or more database(s) and by way of the network protocol can transmit that score back to the client computer and display the score on its graphical user interface. Alternatively or in addition, the computer executable instructions embodying the scoring algorithm and graphical user interface can be downloaded from the server to the client computer, and/or stored or provided on a non-transitory computer readable storage medium such as a hard drive, compact disk, USB flash drive, etc.

Embodiments of the invention provide a simple, understandable, transparent, adjustable, and/or scalable (or any combination of these attributes) scoring algorithm to enable comparison of two or more chemicals based on hazard endpoint assessment results.

According to embodiments, a numeric score is assigned, based on the computer algorithm calculations, to each endpoint hazard assessment where a higher score signals a lower hazard (or vice versa). Necessary factor adjustments are made to scores according to embodiments of the algorithm taught herein, for applicable endpoints to factor the importance of Core Endpoints, and further adjustments to factor assessments based on Limited Evidence.

The following are Examples showing possible embodiments of the scoring algorithm.

### Examples

I. Score Each Endpoint by Hazard Condition

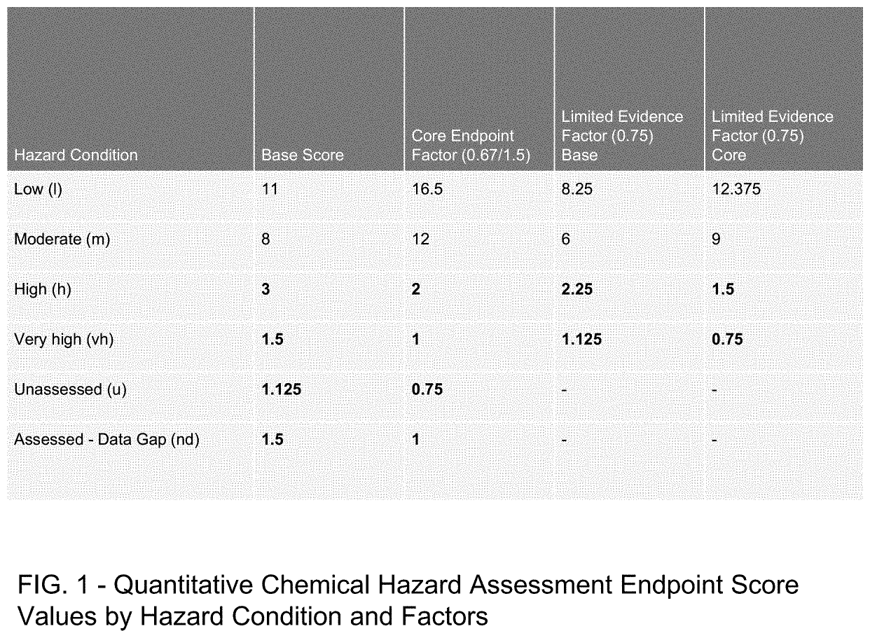

Each endpoint receives a numeric score based on a possible hazard condition and two additional factors: Adjustments for Core Endpoints and Limited Evidence. FIG. 1 is a table showing one example of possible Quantitative Chemical Hazard Assessment Endpoint Scores based on toxicological hazard assessment condition.

Base Score—

The lower the hazard condition, the higher the score, in this example. Very high hazard and unassessed endpoints receive the lowest Base Score of 1.5 and 1.125, respectively. Low hazard endpoints receive the highest Base Score of 11. Moderate hazard endpoints score skews higher on the scale with a Base Score of 8. High hazard endpoints skew lower on the scale with a Base Score of 3.

Core Endpoint Factor—

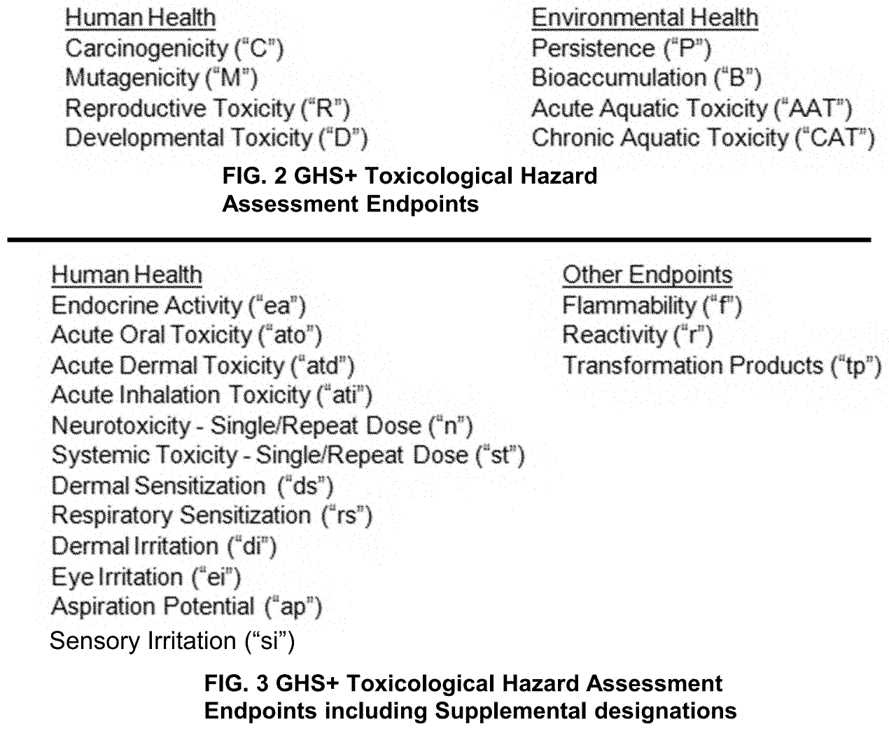

Core Endpoints are those that have higher significance for the human and environmental health of the chemical. In general, Core Endpoints include Human Chronic and Ecotoxicology and Environmental Fate Endpoints. FIG. 2 is a table showing the GHS+ Toxicological Hazard Assessment Endpoints including Core designations according to an embodiment. FIG. 3 is a table showing the GHS+ Toxicological Hazard Assessment Endpoints including Supplemental designations according to an embodiment. Here, there can be flexibility for creating customized scoring configurations that remain fully transparent and add other endpoints of interest to specific product categories (e.g., dermal sensitization) as needed.

Other endpoints (which can be acute or chronic) can include but are not limited to, Liver Toxicity, Kidney Toxicity, Cardiovascular Toxicity, Pulmonary Toxicity, Spleen Toxicity, Immunological Toxicity, Hematological Toxicity, Biotransformation Inducer, and Biotransformation Inhibitor. Other embodiments can include or incorporate data such as the median lethal dose (LD₅₀), median lethal concentration (LC₅₀), No Observed Effect Level (NOEL), No Observed Adverse Effect Level (NOAEL) and Lowest Observed Adverse Effect Level (LOAEL). Other embodiments can include in vitro toxicity endpoints (e.g., Ames mutagenicity assay, sister chromatid exchange (SCE) assay) alternatively or in addition to in vivo toxicity endpoints (e.g., lethality; histopathology). Embodiments can include any toxicity endpoint from any toxicity test or assay or battery of tests or assays known at the time of this disclosure or which become known afterward.

Limited Evidence Factor—

The limited evidence factor is used to adjust scoring when experimental or authoritative data are not available for an endpoint. The specific factor applied depends on the hazard condition—in the case where hazard is Low (l) or Moderate (m) a factor of 0.75 is used adjusting the endpoint score down. When hazard condition is High (h) or Very high (vh) a factor of 1.25 is used to adjust scoring up. The rationale for a varying Limited Evidence Factor based on hazard condition is this: Less certainty for high and very high hazard warrants a slightly higher endpoint score than for the unequivocal very high and high hazard condition. Less certainty for low and moderate hazard warrants a lower endpoint score than for their unequivocal counterparts.

II. Calculate the Quantitative Chemical Hazard Assessment Index Score

Calculating a Quantitative Chemical Hazard Assessment Index score for a chemical is, in this example, a 3-step process:

1. Assign the appropriate score to each endpoint based on hazard condition (i.e., Quantitative Chemical Hazard Assessment Index Endpoint Score);

2. Sum the endpoint scores for the chemical (i.e., Quantitative Chemical Hazard Assessment Index Raw Score); and

3. Divide the Quantitative Chemical Hazard Assessment Index Raw Score by the Quantitative Chemical Hazard Assessment Index Total Possible Score to calculate the Quantitative Chemical Hazard Assessment Index Adjusted Score (aka, Quantitative Chemical Hazard Assessment Index).

In aspects, the Quantitative Chemical Hazard Assessment Index Total Possible Score is 286. In embodiments, the calculation for the total possible score may be formulated as follows:

The Quantitative Chemical Hazard Assessment Index Total Possible Score assumes low hazard for all 8 Core Endpoints:

16.5×8=132

and

The Quantitative Chemical Hazard Assessment Index Total Possible Score also assumes low hazard for all 14 Supplemental Endpoints:

11×15=165

Therefore, 132+165=297

Divide the raw score by 297 and multiply the quotient by 100 to get a Quantitative Chemical Hazard Assessment Index Adjusted Score on a 0-100 scale.

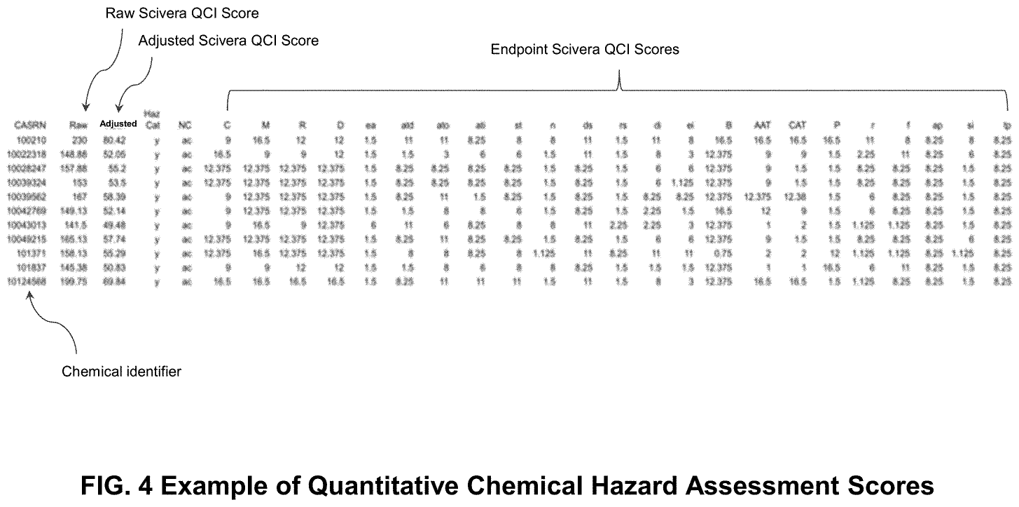

Turning now to the other figures, FIG. 4 presents an example array in table form of endpoint scores, raw quantitative chemical index scores, and adjusted quantitative chemical index scores for a sample set of chemicals by unique identifier. This figure shows a dataset potential for scoring, monitoring, and notifying changes to the dynamic toxicological hazard data and assessment conditions for hundreds of thousands of chemicals in use across millions of formulations and applications in commerce.

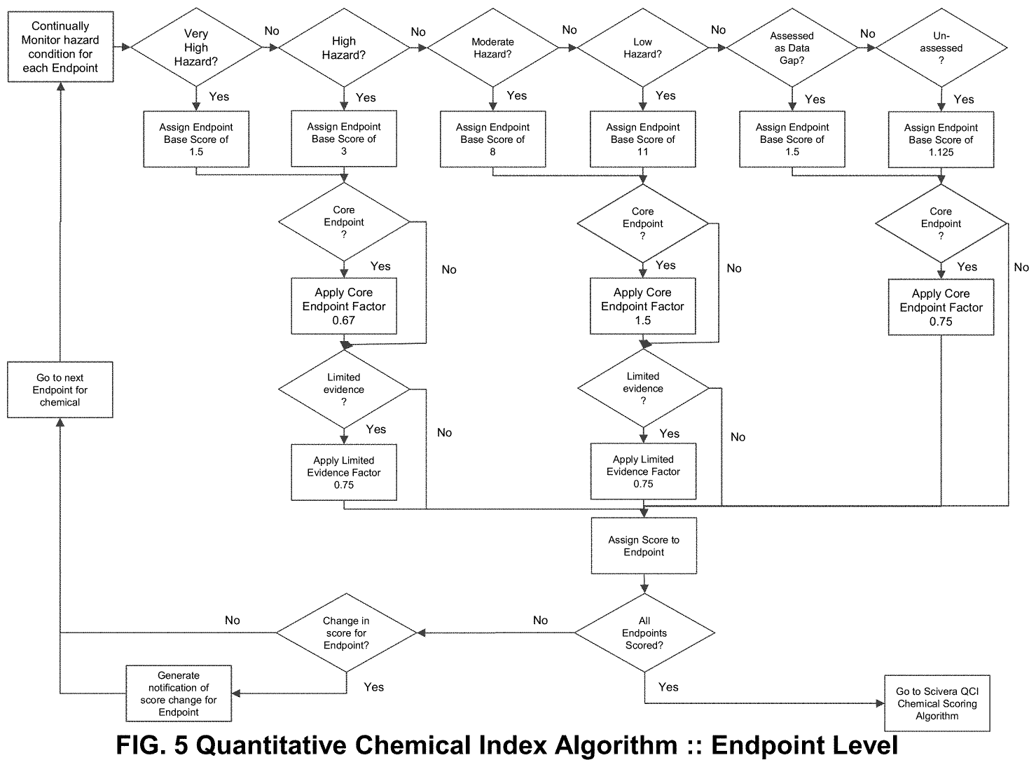

FIG. 5 presents an illustration in flow diagram form of an exemplary algorithm for assigning and iterating the endpoint score for a plurality of human and environmental toxicological endpoints. The algorithm depicts checking for hazard condition, establishing a corresponding score for a plurality of endpoints, and monitoring a plurality of endpoints for changes where a notification results when changes are detected by one or more processors.

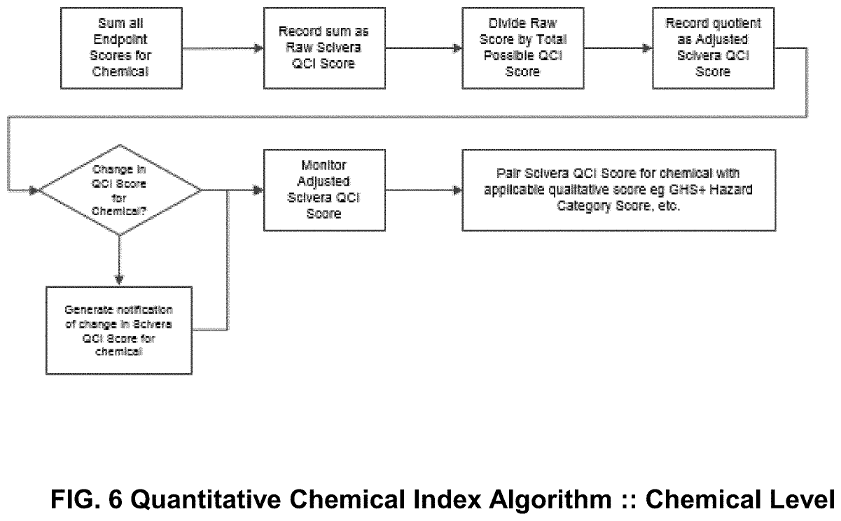

FIG. 6 presents an illustration in flow diagram form of an exemplary algorithm for calculating, monitoring, and updating the raw quantitative chemical index score and the adjusted quantitative chemical index score. Additional aspects for notification to interested parties when changes occur to one or more scores is also included. For example, a processor may continually monitor for changes to accepted assessment criteria for generating hazard conditions, scores, endpoints, and other relevant criteria. If a change is detected, the revised criteria is substituted into the algorithm in order to continually improve the method for quantitative assessment of chemical hazards.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A computer-implemented method of quantitative assessment of one or more chemical hazards, comprising:
providing one or more chemical identifiers;
querying a dynamic database of toxicological assessment information on a plurality of toxicity endpoints based on the one or more chemical identifiers;
assigning a numeric hazard score to the toxicological hazard condition established for each endpoint of the plurality of endpoints based on the information in the database;
calculating a quantitative score using the numeric hazard scores for the plurality of endpoints, which are used to obtain a raw score, and a total score; and
wherein the querying, assigning, and calculating steps are performed by one or more processors.

2. The computer-implemented method of claim 1, wherein a new or updated numeric hazard score for the plurality of endpoints results in a notification by the one or more processors.

3. The computer-implemented method of claim 1, wherein a new or updated quantitative score results in a notification by the one or more processors.

4. The computer-implemented method of claim 1, wherein the plurality of toxicity endpoints comprises a core set of endpoints and a supplemental set of endpoints.

5. The computer-implemented method of claim 1, wherein the numeric hazard scores of the core set of endpoints are weighted higher than the hazard scores of the supplemental set of endpoints.

6. The computer-implemented method of claim 1, wherein the hazard scores are weighted by a limited evidence factor.

7. The computer-implemented method of claim 1, wherein the hazard scores correspond to hazard conditions comprising low, moderate, high, very high, unassessed, assessed, assessed—insufficient data, and/or combinations thereof.

8. The computer-implemented method of claim 7, wherein when the hazard is low or moderate, the hazard score is weighted downward by a limited evidence factor.

9. The computer-implemented method of claim 7, wherein when the hazard is high or very high, the hazard score is weighted upward by a limited evidence factor.

10. The computer-implemented method of claim 7, wherein a low hazard condition is scored higher than a moderate hazard condition, and which moderate hazard condition is scored higher than a high hazard condition.

11. The computer-implemented method of claim 1, wherein a change in hazard condition for one or more endpoints for a chemical results in a corresponding revision of endpoint score.

12. The computer-implemented method of claim 1, wherein a change in the score for one or more endpoints for a chemical results in a corresponding recalculation of the raw score.

13. The computer-implemented method of claim 1, wherein a change in raw score for a chemical results in a corresponding recalculation of the quantitative score.

14. The computer-implemented method of claim 1, wherein a change in index score for a chemical results in a corresponding notification to one or more user querying the quantitative score for that chemical.

15. The computer-implemented method of claim 1, wherein the method provides for a comparison of a first chemical's toxicological characteristics having a first quantitative score to a second chemical's toxicological characteristics having a second quantitative score, wherein the comparison allows for objective and/or quantified selection of a chemical having one or more characteristics.
